(19) United States
(12) Patent Application Publication
(10) Pub. No.: US 2026/0355961 A1
(43) Pub. Date: Nov. 12, 2026

(54) METHOD AND SYSTEM FOR CONTROLLING A ROBOT

(71) Applicant: KUKA Deutschland GmbH, Augsburg (DE)

(72) Inventors: Juan David Munoz Osorio, Augsburg (DE); Jan Bandouch, Muenchen (DE)

(73) Assignee: KUKA Deutschland GmbH, Augsburg (DE)

(21) Appl. No.: 19/125,822

(22) PCT Filed: Sep. 18, 2023
(86) PCT No.: PCT/EP2023/075583

§ 371 Date: Apr. 30, 2025

(30) Foreign Application Priority Data
Nov. 18, 2022 (DE) 10 2022 212 325.5

(51) Int. Cl. B25J 9/16; B25J 9/00

(52) U.S. Cl. CPC B25J 9/1674; B25J 9/0081

(57) ABSTRACT

A method for controlling a robot includes moving the robot, detecting a collision of the robot, and executing an emergency operating mode of the robot as a result of the detected collision. In the emergency operating mode, the robot is controlled such that it can be moved by a hand guidance force exerted manually on the robot and is thereby virtually bound in terms of control technology to a hand guidance path which includes a path at least partially traveled by the robot up to the detected collision.

### CROSS-REFERENCE TO RELATED APPLICATIONS

This application is a national phase application under 35 U.S.C. § 371 of International Patent Application No. PCT/EP2023/075583, filed Sep. 18, 2023 (pending), which claims the benefit of priority to German Patent Application No. DE 10 2022 212 325.5, filed Nov. 18, 2022, the disclosures of which are incorporated by reference herein in their entirety.

### TECHNICAL FIELD

The present invention relates to a method and system for controlling a robot, as well as to a computer program or computer program product for carrying out a method described herein.

### SUMMARY

Moving robots can collide with obstacles.

The object of the present invention is to improve the operation of a robot.

This object is achieved by a method, a system, and a computer program or computer program product, respectively, for carrying out a method as described herein.

According to one embodiment of the present invention, a method for controlling a robot comprises the steps of:
moving the robot, in particular by (operating or controlling) its drive(s);
detecting a collision of the robot, in particular during this movement; and
executing, in particular switching into, an emergency operating mode of the robot, as a result of the detected collision;

wherein in the emergency operating mode the robot, in particular its drives, is or are controlled in such a way that
a) the robot can be moved or guided (manually) by a hand guidance force exerted manually on the robot; and
b) is thereby virtually bound in terms of control technology to a hand guidance path which has or contains a path completely or partially traveled by the robot up to the detected collision, in a further development
i) is the path already or completely traveled up to the detected collision; or
i) is made up of a path portion of a planned (and therefore only partially traveled) path, which path portion has already been traveled up to the detected collision, and a subsequent path portion that has not yet been traveled as a result of the collision.

In one embodiment, the robot comprises at least three, in particular at least six, in one embodiment at least seven, joints or (movement) axes, in particular rotary joints or axes, in one embodiment a robot arm comprising at least three, in particular at least six, in one embodiment at least seven, joints or (movement) axes, in particular rotary joints or axes.

In one embodiment, the at least partially traveled path and/or the hand guidance path is a path of a robot-fixed reference, in one embodiment fixed to the robot end flange or robot end effector, in particular of a reference point or coordinate system, for example the T(ool)C(enter)P(oint). Accordingly, in one embodiment, in the emergency operating mode, the reference can be moved by a hand guidance force exerted manually on the robot and is thereby virtually bound in terms of control technology to a hand guidance path (of the reference) which comprises a path (of the reference) completely or partially traveled by the robot up to the detected collision.

Additionally or alternatively, the at least partially traveled path and/or the hand guidance path is or will be, in one embodiment,

based on target poses specified in advance or before the robot is moved, or

specified on the basis of operator inputs during the movement of the robot, in a further development by a path planner, in particular a path interpolator, and/or determined before or during the movement.

In one embodiment, the robot or the reference is moved automatically and/or in a direction of travel before the collision, on the basis of, in particular along, a or the predetermined path, and thereby at least partially travelled along this path, and an automated further movement and/or further movement in the direction of travel is stopped as a result of the detected collision.

In one embodiment, the at least partially traveled path and/or the hand guidance path is or will be stored, in one further development before the robot travels, in another further development during or after the robot travels.

In one embodiment, the hand guidance path is:
a target path, in particular based on target poses specified in advance or before the movement of the robot and/or specified by a path planner, in particular a path interpolator, and/or before or during the movement of the robot;
a portion of this target path up to the collision; or
an actual (executed) path of the robot.

Accordingly, in one embodiment, the method comprises the steps of:
moving the robot, in particular by (operating or controlling) its drive(s),
   to travel along a specified target path in a direction of travel, in particular with the reference, or
   based on operator inputs during the movement of the robot;
detecting a collision of the robot;
if necessary, stopping any further movement in the direction of travel as a result of the detected collision; and
executing an emergency operating mode of the robot as a result of the detected collision;

wherein in the emergency operating mode the robot is controlled in such a way that it can be moved by a hand guidance force exerted manually on the robot and thereby the robot, in one embodiment the reference, is virtually bound in terms of control technology to
the target path or
the path portion traveled by the robot or the reference up to the detected collision, or
the path actually executed by the robot or the reference up to the detected collision,

wherein in one embodiment, in the emergency operating mode, the robot or the reference is movable manually or by the manual guidance force again in the direction of travel after the further movement has been stopped.

In one embodiment, the at least partially traveled path and/or the hand guidance path is defined by a sequence of poses of the reference and/or joint positions of the robot. In one embodiment, a pose of the reference is an in particular one-, two- or three-dimensional position and/or an in particular one-, two- or three-dimensional orientation of the reference. Accordingly, the at least partially traveled path and/or the hand guidance path, in particular the stored and/or target path, can comprise, in particular be, a path of the reference.

In one embodiment, a collision is detected by sensors, in a further development by means of one or more touch and/or distance sensors, one or more optical sensors, in particular cameras, and/or, in particular in a model-based manner, on the basis of determined, in particular measured, joint and/or drive forces. For a more compact representation, an antiparallel force pair or torque is also generally referred to as a force in the sense of the present invention, so that joint and/or drive forces and a hand guidance force exerted manually on the robot in particular also include joint and/or drive torques or a hand guidance torque exerted manually on the robot.

The robot can be made movable by a hand guidance force exerted manually on the robot in a manner known per se, in particular on the basis of control-technical gravity compensation and/or in such a way that the robot remains in its position in the absence of external forces exerted on it or on an, in particular known, payload guided by the robot.

In one embodiment, the virtual binding to the hand guidance path (realized or brought about) by control technology comprises or brings about or is in one embodiment such that the robot opposes a movement, in particular the reference, in the direction of the hand guidance path, in particular opposite to the direction of travel of the at least partially traveled path up to the detected collision, due to or by a or the hand guidance force exerted manually on the robot with its drives with less resistance than a movement transversely away from the hand guidance path or laterally away from the hand guidance path, in particular a movement in the direction of the hand guidance path, in particular opposite to the direction of travel, does not oppose any (noticeable) resistance and/or prevents a movement laterally or transversely away from the hand guidance path.

Thus, one embodiment of the present invention is based on the concept of switching to a bound hand guidance mode (constrained hand guidance mode) as a result of a detected collision, in which mode the robot, in one embodiment its reference, can be moved by a hand guidance force manually exerted on the robot, but is virtually bound in terms of control technology to an actual path traveled up to the detected collision or a target path at least partially traveled up to the detected collision. In this way, in one embodiment, a person can resolve a jamming situation (by manually moving or hand-guiding the robot) in the event of a collision, while at the same time the probability of further collisions can be reduced by being bound to the path. In contrast to an automated retraction movement along a predetermined path, in this case, in one embodiment, an operator can advantageously determine in particular the distance and/or the speed of the (hand-guided, bound) retraction movement.

In one embodiment, the robot, in a further development the reference, is virtually bound to the hand guidance path in the emergency operating mode by means of admittance control. In this case, in one embodiment, a hand guidance force exerted manually on the robot is determined, in a further development by means of force sensors and/or on the basis of joint and/or drive forces, and transformed into a desired movement of the robot, in a further development of the reference, wherein components of the hand guidance force that seek to cause a deviation from the hand guidance path or components of the desired movement that deviate from the hand guidance path are reduced, preferably hidden or set to zero.

This allows a precise and/or very stiff and/or control-technically simple binding to be realized in one embodiment.

In one embodiment, the robot, in a further development the reference, is virtually bound to the hand guidance path in the emergency operating mode by means of impedance control.

In this case, in one embodiment, a mass-spring-damper behavior of the robot, in a further development of the reference, is achieved in the Cartesian or working space, wherein the mass and/or damping can also be zero and/or the spring can have different stiffnesses in different degrees of freedom of the robot, in a development of the reference, in the Cartesian or working space. In one embodiment, the impedance control is carried out on the basis of or taking into account a or the hand guidance force exerted manually on the robot, which, in a further development, is determined by means of force sensors and/or on the basis of joint and/or drive forces and is transformed into the target drive forces of the robot.

As a result, in one embodiment the robot or the reference can also have a control-technical(ly implemented) compliance transversely away from the hand guidance path or laterally away from the hand guidance path, which compliance is reduced compared to a compliance in the direction of the hand guidance path, in particular against a direction of travel up to the collision. In this way, in one embodiments user can better guide the robot, for example resolve jamming situations or avoid new obstacles.

In one embodiment, the robot, in a further development the reference, is virtually bound to the hand guidance path, in the emergency operating mode, using the Operational Space Control Framework. For this purpose, reference is made to Khatib, O. (1987), A Unified Approach for Motion and Force Control of Robot Manipulators: The Operational Space Formulation, IEEE Jour. On Robotics and Automation, 3(1), 43-53, the contents of which are incorporated in their entirety into the present disclosure. This allows the virtual binding to be implemented in a particularly simple, variable and/or precise manner in one embodiment.

In one embodiment, in the emergency operating mode, the robot, in a further development the reference, is virtually bound in terms of control technology to the hand guidance path in such a way that a hand guidance force of 1 N and/or (even) a hand guidance force of 10 N and/or (even) a hand guidance force of 200 N does not cause the robot, in a further development the reference, to deviate from the hand guidance path. This allows for precise and/or robust binding or bound hand guidance to be realized in one embodiment.

In one embodiment, in the emergency operating mode, the robot, in a further development the reference, is virtually bound in terms of control technology to the hand guidance path in such a way that a deviation of the robot from the hand guidance path can be caused by (even) a hand guidance force of 1 N and/or (even by) a hand guidance force of 10 N and/or (in any case by) a hand guidance force of 200 N against a control technology-induced virtual resistance. In this way, in one embodiment a user can better guide the robot, for example resolve jamming situations or avoid new obstacles.

In a further development, the virtual resistance for a first distance of the robot, in a further development of the reference, from the hand guidance path is greater than for a smaller second distance; in one embodiment, the virtual resistance increases with a distance of the robot, in a further development of the reference, from the hand guidance path. In this way, in one embodiment a user can control the robot even better, for example resolve jamming situations or avoid new obstacles.

In one embodiment, in the emergency operating mode, the robot, in a further development the reference, is virtually bound in terms of control technology to the hand guidance path in such a way that the reference, which is in a current pose on the hand guidance path, is pulled to a target pose (of the reference) on the hand guidance path that is closest to this current pose. This allows a very simple and/or haptically advantageous, particularly intuitive, binding or bound hand guidance to be realized in one embodiment.

In one embodiment, in the emergency operating mode, the robot, in a further development the reference, is virtually bound in terms of control technology to the hand guidance path in such a way that the reference, which is in a current pose on the hand guidance path, is not pulled to a target pose (of the reference) on the hand guidance path that is closest to this current pose; in a further development the robot, in a further development the reference, is (instead) in the emergency operating mode virtually bound in terms of control technology to the hand guidance path in such a way that the reference, which is in a current pose on the hand guidance path, can be moved freely by the hand guidance force in the direction of a path tangent in the target pose (of the reference) that is closest to the current pose. In particular, the path tangent can run through the target pose closest to the current pose and a target pose adjacent thereto on the hand guidance path, or can be determined accordingly. Thus, in particular, a direction through two adjacent target poses is also referred to as a (discretized) path tangent in these target poses in the sense of the present invention.

In one embodiment, this allows for advantageous, in particular (more) sensitive and/or (more) precise, binding or bound hand guidance to be realized, in particular in the case of target poses that are spaced far (further) apart from one another.

In one embodiment, in the emergency operating mode a movement of the robot is damped in terms of control technology; in a further development, a damping force is realized in terms of control technology, which force counteracts a movement of the robot and/or increases with a velocity of the robot.

Additionally or alternatively, in one embodiment a velocity of the robot is or will be limited more in the emergency operating mode than when traveling along the path traveled up to the collision.

As a result, in one embodiment the safety can be increased.

According to one embodiment of the present invention, a system for controlling a robot, in particular by hardware and/or software, in one embodiment programmatically, is set up to carry out a method described here and/or comprises means for executing an emergency operating mode of the robot as a result of a detected collision, wherein the system or its means controls the robot in the emergency operating mode in such a way that it can be moved by a hand guidance force exerted manually on the robot and is thereby virtually bound in terms of control technology to a hand guidance path which comprises a path at least partially traveled by the robot up to the detected collision, or the system or its means is set up for this purpose.

In one embodiment, the system or its means comprises:
means for moving the robot, in particular drives of the robot and/or means for controlling the drives of the robot; and/or
means for detecting a collision of the robot, in particular sensors and/or means for processing sensor signals or collision detection information based thereon; and/or
(means for executing (the emergency operating mode by means of)) an impedance control or admittance control for virtually binding the robot to the hand guidance path; and/or
means for virtually binding the robot in terms of control technology to the hand guidance path in the emergency operating mode such that a hand guidance force of 1 N and/or a hand guidance force of 10 N and/or a hand guidance force of 200 N cannot cause the robot to deviate from the hand guidance path, or such that a hand guidance force of 1 N and/or a hand guidance force of 10 N and/or a hand guidance force of 200 N can cause the robot to deviate from the hand guidance path against a control technology-induced virtual resistance, wherein in one embodiment this virtual resistance is greater for a first distance of the robot from the path than for a smaller second distance, and in a further development increasing with a distance of the robot from the path; and/or
means for virtually binding the robot in terms of control technology to the hand guidance path in the emergency operating mode in such a way that a or the robot-fixed reference located in a current pose on the hand guidance path is pulled to a target pose on the hand guidance path that is closest to this current pose, or in such a way that a or the robot-fixed reference located in a current pose on the hand guidance path is not pulled to a target pose on the hand guidance path that is closest to this current pose, in one embodiment (instead) can be moved freely in the direction of a path tangent in the target pose closest to the current pose by the hand guidance force; and/or
means for control-technically damping a movement of the robot in the emergency mode; and/or
means for limiting a velocity of the robot in the emergency operating mode more than when traveling along the path at least partially traveled up to the collision.

A system and/or a means in the sense of the present invention may be designed in hardware and/or in software, and in particular may comprise at least one, in particular digital, processing unit, in particular microprocessor unit (CPU), graphic card (GPU) or the like, which is preferably data-connected or signal-connected to a memory system and/or bus system, and/or one or multiple programs or program modules. The processing unit may be designed to process commands that are implemented as a program stored in a memory system, to detect input signals from a data bus and/or to issue output signals to a data bus. A memory system may comprise one or more, in particular different, storage media, in particular optical, magnetic, solid-state, and/or other non-volatile media. The program may be designed in such a way that it embodies or is capable of carrying out the methods described herein, so that the processing unit can carry out the steps of such methods and thus, in particular, can control the robot. Controlling in the sense of the present invention preferably comprises regulating. In one embodiment, a computer program product may comprise, in particular be, an, in particular computer-readable and/or non-volatile, storage medium for storing a program or instructions or with a program stored thereon or with instructions stored thereon. In one embodiment, execution of said program or said instructions by a system or controller, in particular a computer or an arrangement of multiple computers, causes the system or controller, in particular the computer(s), to carry out a method described herein or one or more steps thereof, or the program or instructions are configured to do so.

In one embodiment, one or more, in particular all, steps of the method are fully or partially computer-implemented or one or more, in particular all, steps of the method are fully or partially automated, in particular by the system or its means. In one embodiment, the system comprises the robot.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically depicts an exemplary system for controlling a robot according to one embodiment of the present invention; and

FIG. 2 illustrates a method for controlling the robot according to one embodiment of the present invention.

### DETAILED DESCRIPTION

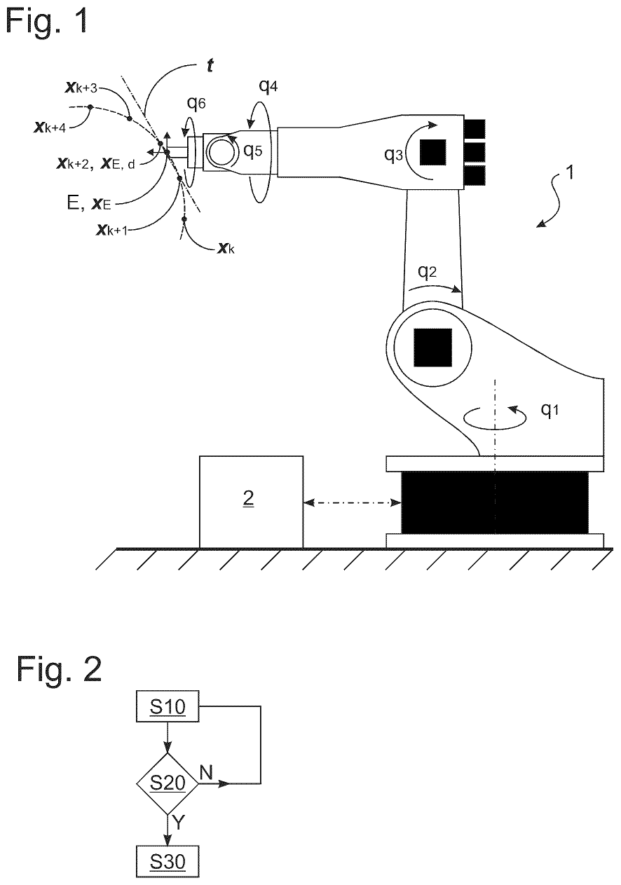

FIG. 1 shows a robot (arm) 1 comprising, in the exemplary embodiment, six rotary joints, the joint positions of which are indicated by q₁, . . . , q₆=q, and a reference E fixed to the robot end effector or flange, the current pose of which reference is indicated by x_{E}, as well as a robot controller 2.

xₖ, . . . , xₖ₊₃ indicates a predetermined target path of robot 1 or its reference E. In this case, by way of example, xₖ₊₂ indicates the target pose closest to the current pose x_{E} and t indicates a path tangent to this target pose x_{E},d closest to the current pose x_{E}. In the embodiment, the manual guidance path is, by way of example, the specified target path.

The dynamics of the robot can generally be described by the equation

τ=M·d²q/dt²+c(q,dq/dt)+g(q) (1)

with the mass matrix M, the gyroscopic forces c, the gravitational forces G and the generalized forces r in the space of joint coordinates q being described.

Using the well-known concept of the Operational Space Control Framework, drive target torques τ_{d} in the joints of the robot 1 can advantageously be determined according to

τ_{d}=J^{T}·{Λ·[Kₚ·(x_{E,d}−x_{E})+K_{d}·(dx_{E},d/dt−dx_{E}/dt)]+μ+p}++N·[M·(−K_{damp}·dq/dt)+c+g] (2)

where the transposed J^{T} can be the Jacobian matrix J=∂(d×x_{E}/d t)/∂(d q/d t), the mass matrix in the operational space Λ=(J·M⁻¹·J^{T})⁻¹, the gyroscopic forcesu μ=J^{T}·c−Λ·d J/d t·d q/d t and gravitational forces p=J^{T}·G in the Operational Space, the zero space projector N=1−J^{T}·J^{T} with J^{T}=M⁻¹·J^{T}·Λ, the stiffness Kₚ of a virtual spring of the binding, which can in particular be a scalar factor kₚ, the damping K_{d} of a virtual damper of the binding, which can in particular be a scalar factor k_{d}, and the damping-K_{damp}·dq/dt which depends on the velocity of the robot, is opposite to its movement and is projected into the zero space of the binding, where K_{damp} can also be a scalar factor k_{damp}.

The target pose x_{E,d} on the path that is closest to the current pose x_{E} of the reference E located on the path can be identified as that of the target poses xᵢ for which a standard |xᵢ−x_{E}| is minimal, in FIG. 1:

x_{E,d}=xᵢ=∈{x₁, . . . ,xₖ₋₂,xₖ₋₁,xₖ,xₖ₊₁, . . . ,xₙ} with|xᵢ−x_{E}|=minimal

By the above implementation (2), the reference E located in the current pose on the path is pulled by control technology by a virtual spring to the target pose on the path closest to this current pose (cf. in particular the term Kₚ·(x_{E,d}−x_{E})). As soon as the operator, who manually guides the robot 1, has moved the reference far enough on the path beyond the target pose, to which the reference is virtually bound in terms of control technology, that another target pose on the path is closer to the (now or new) current pose of the reference, this other target pose forms the new target pose closest to the current pose, to which the reference is then virtually bound in terms of control technology. In other words, the spring “snaps” to the target pose closest to the current pose in each case.

In particular, to make the hand guidance smoother, one embodiment proceeds as follows:

The controller 2 determines a path tangent t in the target pose x_{E},d closest to the current pose, for example with the direction vector z_{d}=(x_{E,d}−x_{E,d-1})/|x_{E,d}−x_{E,d-1}|, the rotation axis u=[0 0 1]^{T}×Z_{d} and the rotation angle 0=([0 0 1]^{T}·Z_{d})/([0 0 1]^{T}|·|z_{d}|) of a rotation matrix R, which represents a rotation about this rotation axis and this rotation angle, transforms the Jacobian matrix with this rotation matrix into

$$\begin{matrix}{}^{d} J = & ⌈ \begin{matrix}{R}^{T} & 0\end{matrix} ⌉ \cdot J \\ & ⌊ \begin{matrix}0 & {R}^{T}\end{matrix} ⌋\end{matrix}$$

and calculates the above equation (2), where J is replaced by ^{d}J, x_{E,d} by ^{d}x_{E,d}=R^{T}·x_{E,d}, x_{E} by ^{d}x_{E}=R^{T}·x_{E}, dx_{E,d}/dt by ^{d}x_{E,d}/dt=R^{T}·^{d}x_{E,d}/dt and ^{d}x_{E}/dt by ^{d}x_{E}/dt=R^{T}·dx_{E}/dt,Λ, μ and p is calculated using ^{d}J instead of J and only the first two rows or x- and y-components of the Jacobian matrix ^{d}J and the poses or velocities ^{d}x_{E,d}, ^{d}x_{E}, ^{d}x_{E}/dt or ^{d}x_{E,d}/dt are used. In this way, the reference E located in the current pose x_{E} on the path is not pulled to the target pose x_{E,d} on the path closest to the current pose, as in the variant first explained with reference to equation (2), but can be moved in the direction of the path tangent t in the target pose closest to the current pose x_{E,d} by the hand guidance force, since the corresponding binding (component) is hidden.

In a method shown in FIG. 2 for controlling the robot 2 by the robot controller 1, in a first step S10 the robot travels the specified target path and is monitored in the process for collisions. If a collision is detected during travel (step S20: “Y”), the system switches to an emergency operating mode and, in the emergency operating mode, the robot is controlled in the manner explained above in such a way that it can be moved by a hand guidance force exerted manually on the robot and is thereby virtually bound in terms of control technology to a hand guidance path which comprises a path at least partially traveled by the robot up to the detected collision (FIG. 2: step S30). Otherwise (step S20: “N”) the robot continues to travel along the specified target path.

In contrast to an automated retraction movement, the operator can determine how far and how fast the robot, which is bound to the at least partially traveled path, moves back by appropriately metering the hand guidance force and, if necessary, move it further or again in the previous direction of travel.

Although exemplary embodiments have been explained in the preceding description, it is pointed out that a large number of modifications is possible.

Thus, in the present embodiment, a predetermined target path was used as the hand guidance path. Similarly, an actual (executed) path can also be used, which can improve reliability and enable use when moving the robot based on operator input during the movement. Alternatively, the use of a target path specified based on predefined target poses can be computationally advantageous and/or compensate for unwanted deviations from the target path before the collision.

It is also pointed out that the exemplary embodiments are merely examples that are not intended to restrict the scope of protection, the applications, and the structure in any way. Rather, the preceding description provides a person skilled in the art with guidelines for implementing at least one embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

List of reference signs

| | |
|---|---|
| 1 | Robot (arm) |
| 2 | (Robot) controller |
| E | Robot-fixed reference |
| q₁, . . . , q₆ | Joint coordinates |
| t | Path tangent |
| xₖ, . . . , xₖ₊₃ | Target poses |
| x_{E} | Current pose |
| x_{E, d} | Target pose closest to the current pose |

What is claimed is:

1. Method for controlling a robot (1), comprising the steps of:
moving (S10) the robot;
detecting (S20) a collision of the robot; and
executing (S30) an emergency operating mode of the robot as a result of the detected collision;
wherein in the emergency operating mode the robot is controlled in such a way that it can be moved by a hand guidance force exerted manually on the robot and is thereby virtually bound in terms of control technology to a hand guidance path which has a path at least partially traveled by the robot up to the detected collision.

2-12. (canceled)

13. Method according to claim 1, characterized in that in the emergency operating mode the robot is virtually bound to the hand guidance path by means of impedance control, in particular with the aid of the Operational Space Control Framework.

14. Method according to claim 1, characterized in that in the emergency operating mode the robot is virtually bound to the hand guidance path by means of admittance control.

15. Method according to claim 1, characterized in that in the emergency operating mode the robot is virtually bound to the hand guidance path in terms of control technology in such a way that a hand guidance force of 1 N and/or a hand guidance force of 10 N and/or a hand guidance force of 200 N cannot cause the robot to deviate from the hand guidance path.

16. Method according to claim 1, characterized in that in the emergency operating mode the robot is virtually bound to the hand guidance path in terms of control technology in such a way that a deviation of the robot from the hand guidance path can be caused by a hand guidance force of 1 N and/or a hand guidance force of 10 N and/or a hand guidance force of 200 N against a control technology-induced virtual resistance.

17. Method according to claim 16, characterized in that the virtual resistance is greater for a first distance of the robot from the hand guidance path than for a smaller second distance, in particular increases with a distance of the robot from the hand guidance path.

18. Method according to claim 1, characterized in that in the emergency operating mode the robot is virtually bound to the hand guidance path in terms of control technology in such a way that a robot-fixed reference (E) located on the hand guidance path in a current pose (xE) is pulled to a target pose (xE,d), on the hand guidance path, closest to said current pose.

19. Method according to claim 1, characterized in that in the emergency operating mode the robot is virtually bound to the hand guidance path in terms of control technology in such a way that a robot-fixed reference (E) located on the path in a current pose (xE) is not pulled to a target pose (xE,d), on the hand guidance path, closest to said current pose, in particular the robot instead can be moved freely in the direction of a path tangent (t) in the target pose closest to the current pose, by the hand guidance force.

20. Method according to claim 1, characterized in that in the emergency operating mode a movement of the robot is damped in terms of control technology.

21. Method according to claim 1, characterized in that in the emergency operating mode a velocity of the robot is more limited than when traveling along the path traveled up to the collision.

22. System for controlling a robot (1), which comprises means for executing an emergency operating mode of the robot as a result of a detected collision, wherein in the emergency operating mode the robot is controlled such that it can be moved by a hand guidance force exerted manually on the robot and is thereby virtually bound in terms of control technology to a hand guidance path which comprises a path traveled by the robot up to the detected collision.

23. Computer program or computer program product, wherein the computer program or computer program product includes instructions, in particular stored on a computer-readable and/or non-volatile storage medium, which, when executed by one or more computers or a system, cause the computer(s) or system to carry out a method according to claim 1.
